(19) United States
(12) Patent Application Publication
(10) Pub. No.: US 2024/0342747 A1
(43) Pub. Date: Oct. 17, 2024

(54) MATERIAL SUPPLY PUMP FOR SPACER OF INSULATING GLASS

(71) Applicants: CORNING INCORPORATED, CORNING, NY (US); G-ONE AUTOMATION CO., LTD.

(72) Inventor: GEON-HWA LEE, Gwangsan-gu (KR)

(21) Appl. No.: 18/611,239

(22) Filed: Mar. 20, 2024

(30) Foreign Application Priority Data
Mar. 20, 2023 (KR) 10-2023-0036071

(51) Int. Cl. B05C 11/10; C03C 17/00; C03C 17/32; E06B 3/663; E06B 3/673

(52) U.S. Cl. CPC B05C 11/1026; B05C 11/1042; C03C 17/002; C03C 17/32; E06B 3/66328; E06B 3/6733

(57) ABSTRACT

A pumping device for spacer material, such as TPS (Thermoplastic Spacer) material for insulated glazing units (IGUs). The pumping device includes a pumping unit driven by a control signal, including a cylinder driven by the control signal, a rod reciprocating at regular intervals by the operation of the cylinder, a piston installed at an end of the rod and reciprocating synchronously with the rod to pump spacer material in the drum in predetermined amounts, a through-hole formed for the passage of the piston and rod, a pressure plate sealingly pressing the spacer material in the drum and surrounding the rod, and a pumping housing sealingly enclosing the rod. The pressure plate includes multiple suction holes formed for the passage of spacer material in the drum, and these suction holes communicate with the through-hole.

### CLAIM OF PRIORITY

This application claims priority to Korea Patent Application 10-2023-0036071, titled “TPS Supply Pump for Spacer of Insulating Glass,” filed 20 Mar. 2023, the entirety of which is incorporated by reference.

### TECHNICAL FIELD

The present disclosure relates to a pumping device for material that forms a spacer (e.g., thermo plastic spacer-“TPS”-material) used in insulated glazing units (“IGUs”), and more particularly, to a pumping device for TPS material used in IGUs to supply the TPS material to a nozzle device for coating TPS spacers on a surface of a glass pane incorporated into an IGU with a specified height and width.

### BACKGROUND

Recently, there has been a gradual increase in the use of IGUs due to the improvement of living standards and advancements in manufacturing technology, despite their relatively high cost.

The demand for IGUs is increasing due to the desire of consumers for a more comfortable living environment, driven by the improvement in noise reduction and heating efficiency, not only in large buildings but also in small shops and individual homes.

IGUs are formed by combining two or more glass panes with a specified gap between them. Compared to single pane windows, the IGUs not only minimize the loss of indoor energy but also mitigate the decrease in surface temperature of the inner glass pane despite external temperature reduction, thereby reducing the occurrence of condensation. Additionally, they offer excellent soundproofing capabilities, effectively blocking the transmission of noise between indoor and outdoor environments.

Traditional IGUs consist of a first glass pane facing the interior of the building, a second glass pane forming the exterior wall of the building, and spacers that maintain a certain distance between the first and second glass panes to create a defined space.

Spacers are typically composed of aluminum material to provide sturdy support between the separated glass panes.

However, spacers made of aluminum material have a high thermal conductivity, leading to a significant reduction in thermal insulation effectiveness. Consequently, this can result in condensation formation due to temperature differences between the inner and outer surfaces of the glass, causing significant obstruction to visibility.

To address these issues, spacers made of synthetic resin have been proposed. For example, Korean Registered U.S. Pat. No. 1,021,851, incorporated herein by reference in its entirety, has been disclosed in this regard.

Spacers made of synthetic resin can utilize materials such as Thermo Plastic Spacer (TPS), which contains a desiccant, such as polyisobutylene, to enhance thermal insulation.

These TPS spacers are applied to one surface of a glass pane with a specific width and height using a separate nozzle device, which constitutes a TPS material supply apparatus.

The TPS material supply apparatus comprises a nozzle device that moves under control signals to apply TPS spacers to one surface of a glass pane with a specific width and height. Additionally, it includes a TPS material pumping device to pump and supply the TPS material to be applied by the nozzle device.

Such TPS material pumping devices are disclosed in Korean Patent Registration No. 10-1336313, which pertains to the TPS material supply apparatus of an IGU manufacturing device.

However, conventional TPS material pumping devices have the drawback of losing some of the TPS material filled in the drum during the pumping process due to the reciprocating motion of the piston, resulting in the inability to pump the predetermined quantity.

Specifically, TPS material possesses very high viscosity properties, so the reciprocating motion of a piston with a certain diameter alone cannot pump the required amount properly. As a result, improper supply of TPS material to the nozzle device leads to the application of defective TPS spacers, ultimately resulting in the production of defective IGUs.

### SUMMARY

The present disclosure is conceived in view of the aforementioned problems. The technical problem that the present disclosure aims to solve is to provide a pumping device for TPS material used as a spacer in an IGU, which improves the pumping performance for high viscosity TPS material to ensure smooth supply of the predetermined amount of TPS material to the nozzle device.

In other words, the pumping device pumps high viscosity TPS material filled in the drum during the rise and fall of the piston's reciprocating motion, while minimizing the loss of TPS material during the pumping process. This ensures an adequate supply of TPS material to the nozzle device, preventing the application of defective TPS spacers and ultimately enabling the production of high-quality IGUs.

To address the above-mentioned problem, the pumping device for TPS material used as spacers for IGUs, according to embodiments of the present disclosure, is structured as follows: the pumping unit, driven by a control signal, comprises a cylinder; a rod unit reciprocating at regular intervals due to the driving of the cylinder; a piston installed at an end of the rod unit and reciprocating with the rod unit to pump TPS material in the drum in predetermined quantities; a pressure plate formed with multiple suction holes for the TPS material to pass through in the drum and pressurize the TPS material in the drum in a sealed manner; and a pumping housing that seals the rod unit. The pressure plate may be configured with multiple suction holes that are connected to the through-hole, allowing the TPS material to pass through in conjunction with the through-hole.

Among the multiple suction holes, the suction hole positioned relatively close to the through-hole can be connected to the lower part of the through-hole, while the suction hole positioned relatively far from the through-hole can be connected to the upper part of the through-hole.

Additionally, the rod unit comprises a first rod with a cross-sectional diameter smaller than the inner diameter of the pumping housing, forming a clearance between the pumping housing and the rod; and a second rod coupled to the first rod and accommodating the piston at its end. The second rod includes a first coupling portion accommodating the piston and extending from the first coupling portion by a certain length to form a second coupling portion. The second coupling portion is formed with a diameter smaller than the inner diameter of the pumping housing and includes a valve check with a certain amount of vertical play. Furthermore, it extends from the second coupling portion by a certain length to form a smaller diameter portion, followed by a larger diameter portion that is still smaller than the inner diameter of the pumping housing. The larger diameter portion includes multiple guide holes penetrating through the front and rear along the circumference. Additionally, a flange may be formed with a certain thickness around the circumference of the front end of the larger diameter portion, with a cross-sectional diameter larger than that of the larger diameter portion and similar to or the same as the inner diameter of the pumping housing.

In this case, the smaller diameter portion accommodates the second check valve, while a shoulder portion and a baffle may be formed around the inner circumference of the pumping housing to limit the vertical movement of the second check valve.

Meanwhile, the space between the piston and the second check valve forms the first pumping space, and the space between the larger diameter portion of the second rod and the second check valve forms the second pumping space.

Furthermore, at the end of the first rod, a third check valve is installed to allow for vertical movement with a certain interval. The third check valve can open and close the multiple guide holes formed in the larger diameter portion.

Additionally, on one side of the pumping housing, a heating pipe for supplying TPS material to the nozzle device is installed to communicate, and the space between the third check valve and the heating pipe forms the third pumping space.

In this case, it is desirable for the volume of the second pumping space to be larger than the volume of the third pumping space.

Meanwhile, the piston is formed with a convex-shaped bottom, with a central hole formed for the accommodation of the end of the rod unit. Around the perimeter of this hole, multiple inlet ports can be formed at regular intervals.

The other specific details of the present disclosure are included in the detailed description and drawings.

According to the pumping device for TPS material for use as spacers in IGUs according to embodiments of the present disclosure, the pumping performance for high viscosity TPS material is significantly improved. This allows for smooth supply of the predetermined amount of TPS material to the nozzle device, thereby providing an effective solution.

In other words, during the reciprocating motion of the piston, the high viscosity TPS material filled in the drum is pumped. However, minimizing the loss of TPS material during the pumping process ensures an adequate supply of TPS material to the nozzle device. This prevents the application of defective TPS spacers, ultimately leading to the production of high-quality IGUs.

The effects of the present disclosure are not limited to the examples provided above and encompass various other benefits that are included within this specification.

### BRIEF DESCRIPTION OF THE DRAWINGS

In the Drawings:

FIG. 1 is a front view with a partial cross-section to illustrate the configuration of the pumping device for TPS material used as spacers in IGUs according to an embodiment of the present disclosure;

FIG. 2 is a side perspective view of the pumping unit in FIG. 1;

FIG. 3 is a partially enlarged sectional view to show the internal configuration of the pumping unit in the pumping device for TPS material used as spacers in IGUs according to embodiments of the present disclosure, depicting the sectional view when the piston is in a lowered state;

FIG. 4 is a cross-sectional view of FIG. 3;

FIG. 5 is a sectional view like FIG. 3 but showing the piston in a raised state;

FIG. 6 is a cross-sectional view of FIG. 5;

FIG. 7 is a perspective view of a cross-section of the piston of the pumping device for TPS material used as spacers in IGUs according to an embodiment of the present disclosure;

FIG. 8 is a perspective view of a cross-section of a second rod in the pumping device for TPS material used as spacers in IGUs according to an embodiment of the present disclosure;

FIG. 9 is a bottom view of the compression plate of the pumping device for TPS material used as spacers in IGUs according to an embodiment of the present disclosure; and

FIG. 10 is a cross-sectional view along line A-A of FIG. 9.

### DETAILED DESCRIPTION

The advantages and features of the present disclosure, as well as the methods for achieving them, will become apparent from the detailed embodiments described with reference to the accompanying drawings. However, it should be understood that the present invention is not limited to the embodiments disclosed below, but can be implemented in various other forms. The disclosed embodiments are merely provided to fully disclose the invention and to provide those skilled in the art to which the disclosure pertains with a complete understanding of the scope of the disclosure. The invention is defined only by the scope of the claims. Throughout the specification, like reference numerals denote like components.

Therefore, in some embodiments, well-known process steps, well-known structures, and well-known techniques are not described in detail to avoid ambiguity in the interpretation of the present disclosure.

The terminology used in this specification is for describing embodiments and is not intended to limit the claims. In this specification, the singular includes the plural unless specifically mentioned otherwise. The terms “comprises” and/or “comprising” used in the specification denote the inclusion of one or more other components, steps, and/or operations in addition to those mentioned, without excluding the presence or addition of one or more other components, steps, and/or operations. Additionally, “and/or” encompasses each of the items mentioned and any combination of one or more of them.

Furthermore, the embodiments described in this disclosure will be explained with reference to schematic diagrams, cross-sectional views, side views, and/or schematic diagrams, which represent ideal examples of the disclosure. Therefore, the forms of the exemplary views may be altered due to manufacturing techniques and/or permissible tolerances. Consequently, the embodiments of the present disclosure are not limited to the specific forms illustrated but also encompass variations in form that may arise from manufacturing processes. Additionally, in each drawing of the embodiments of the present disclosure, individual components may be depicted in an enlarged or reduced scale for the convenience of explanation.

Below, the pumping device for the TPS material for IGUs according to embodiments of the present disclosure will be described in detail with reference to the attached exemplary drawings.

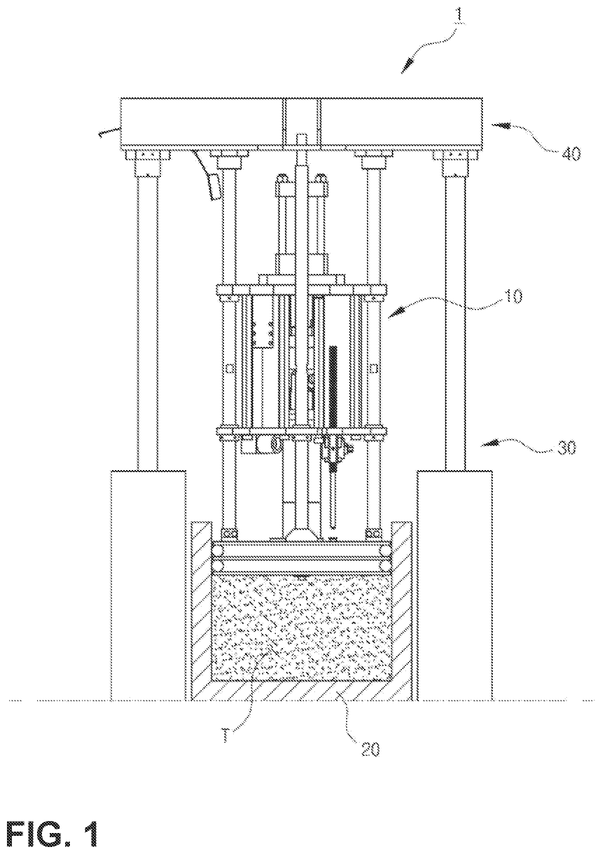

As mentioned above, FIG. 1 is a front view with partial cross-section showing the configuration of a pumping device 1 for the TPS material for IGUs according to embodiments of the present disclosure.

As depicted in FIG. 1, the pumping device 1 for the TPS material for IGUs according to embodiments of the present disclosure includes a pumping unit 10 that pumps a predetermined amount of thermal plastic spacer (“TPS”) material T from a drum 20 filled with the TPS material T and supplies it to a nozzle device (not shown) while pressurizing the TPS material T filled in the drum 20. It also comprises a support unit 40 that supports the pumping unit 10 and descends according to the amount of TPS material T filled in the drum 20 to continuously pressurize the TPS material T, and a lifting unit 30 that raises and lowers the support unit 40. Although the pumping device 1 is discussed in terms herein of pumping the TPS material T, it should be understood that the pumping device 1 can pump any material, including any spacer material suitable to form a spacer for an IGU, and the claims should not construed as limited solely to the pumping of, or configuration to pump, TPS material T.

Here, the lifting unit 30 can be implemented to raise and lower using various conventional means such as hydraulic, pneumatic, ball screw, etc.

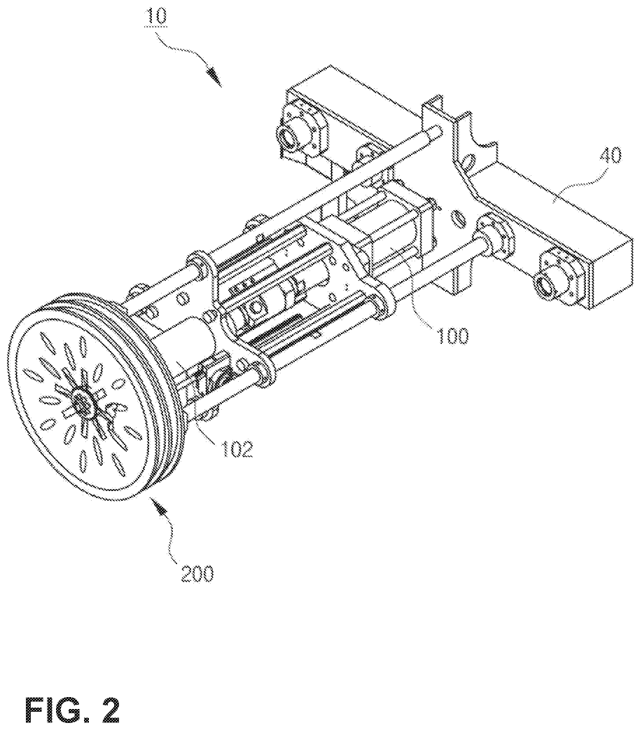

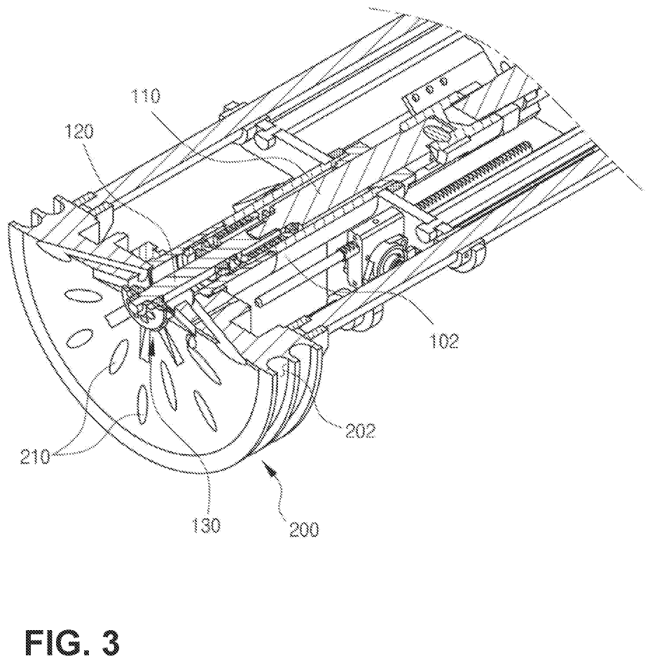

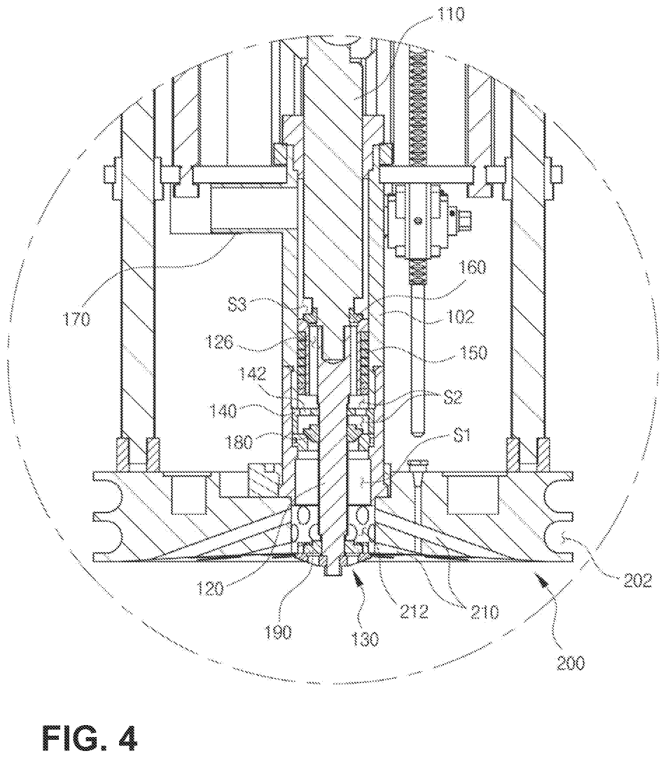

As mentioned, FIG. 2 is a perspective view of the pumping unit 10 from FIG. 1, and FIG. 3 is a partial sectional view showing the internal configuration of the pumping unit 10 in the pumping device 1 for the TPS material T to form the spacer of IGUs according to the present disclosure, illustrating a partial enlargement of the section where the piston 130 is lowered. As mentioned, FIG. 4 is a sectional view of FIG. 3.

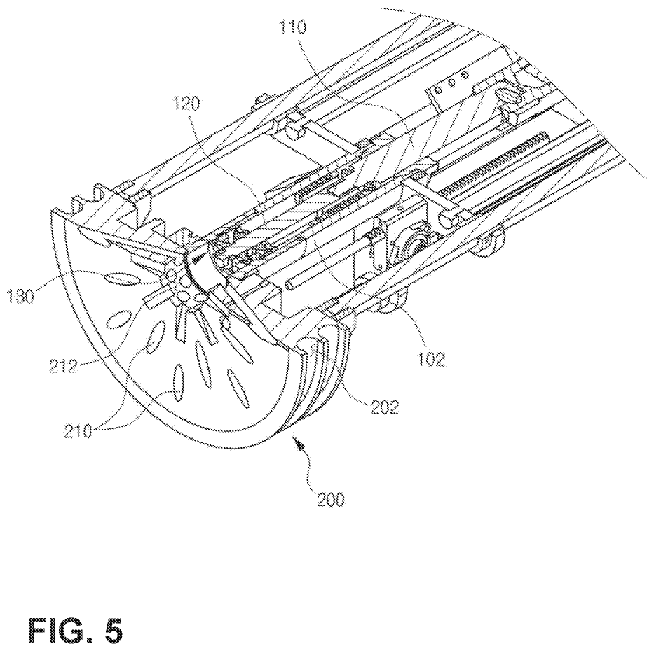

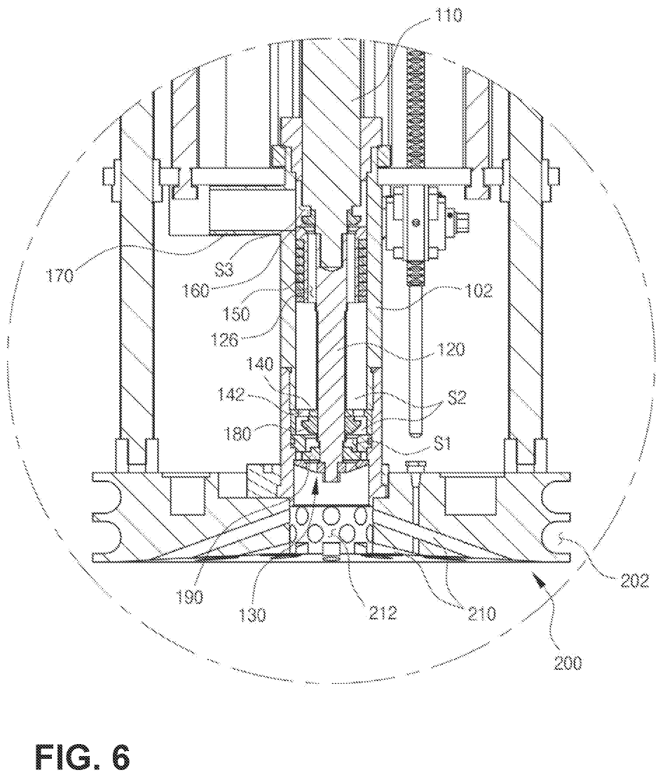

Additionally, FIG. 5 is a sectional view showing the section where the piston 130 is in the raised state from FIG. 3, and FIG. 6 is a sectional view of FIG. 5.

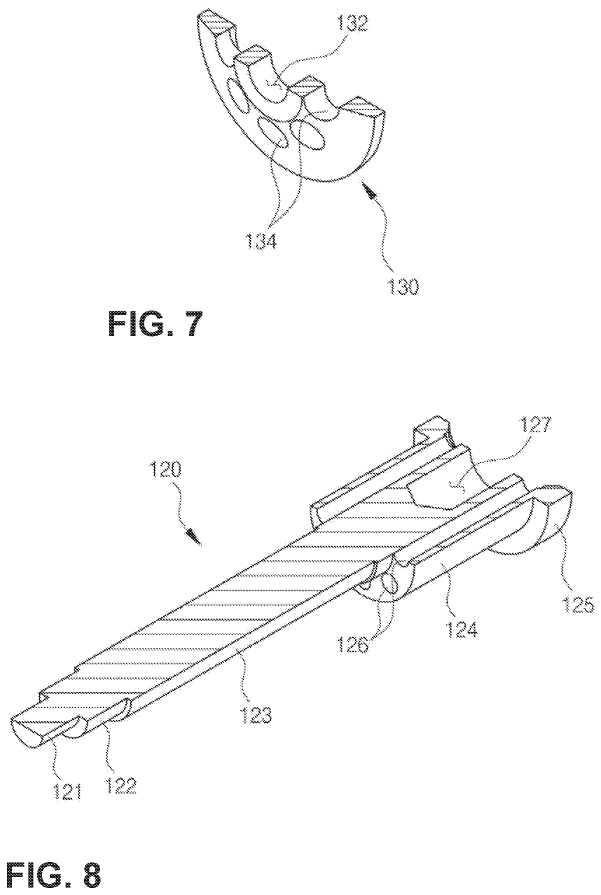

Furthermore, FIG. 7 is a schematic view illustrating the configuration of the piston 130 in the pumping device 1 for the TPS material T used to form spacers in IGUs according to an embodiments of the present disclosure, and FIG. 8 is a schematic view illustrating the configuration of a second rod 120 in the pumping device 1 for the TPS material T used to form spacers in IGUs according to embodiments of the present disclosure.

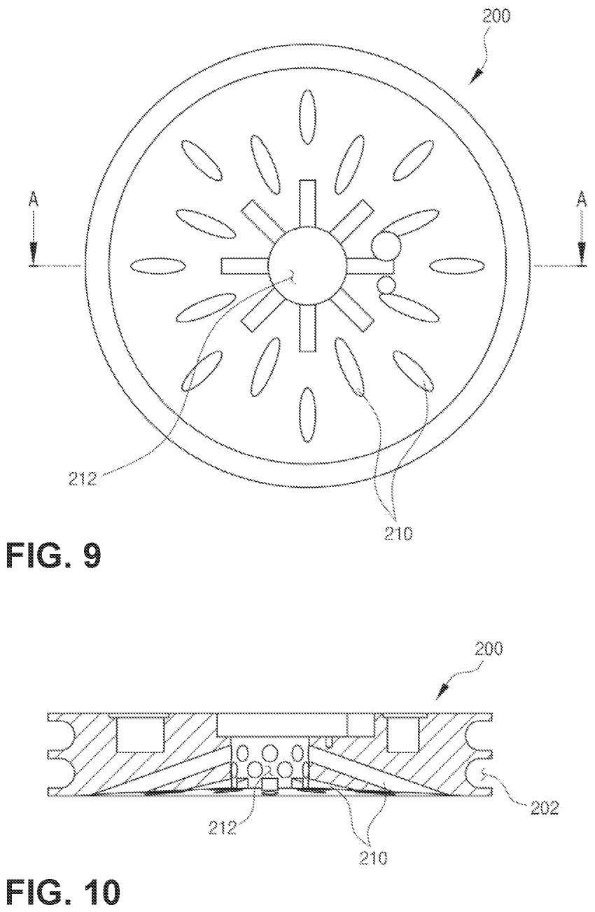

And FIG. 9 is a bottom view of the pressure plate 200 in the pumping device 1 for TPS material used to form spacers in IGUs according to embodiments of the present disclosure, and FIG. 10 is a sectional view of FIG. 9.

As shown in FIGS. 2 to 10, the pumping unit 10 provided in the pumping device 1 for TPS material T used to form spacers in IGUs according to embodiments of the present disclosure includes a cylinder 100 driven by a control signal, a rod unit 110, 120 reciprocating at regular intervals by the driving of the cylinder 100, a piston 130 installed at the end of the rod unit 110, 120 and reciprocating synchronously to pump TPS material T within the drum 20 in predetermined quantities, a pressure plate 200 pressurizing the TPS material T within the drum 20 by forming a through-hole 212 through which the piston 130 and rod unit 110, 120 pass, and a pumping housing 102 enveloping the rod unit 110, 120 to maintain a sealed environment.

The cylinder 100 is preferably provided as a hydraulic cylinder, but it is not limited thereto, and various conventional means such as pneumatic cylinders, actuators, ball screws, etc., can also be provided.

The rod unit 110, 120 may include a first rod 110 with a cross-sectional diameter smaller than the inner diameter of the pumping housing 102, forming a clearance between the pumping housing 102 and the first rod 110, and a second rod 120 coupled to the first rod 110 and having a piston 130 housed at its end. The specific shapes and operational relationships of these first rod 110 and second rod 120 will be described in detail later.

The piston 130, housed at the end of the second rod 120 of the rod unit, moves downward with the reciprocating motion of the rod unit, pumping the TPS material T filled in the drum 20 through the communication hole 212 of the pressure plate 200 into the pumping housing 102. Additionally, piston 130 moves upward with the reciprocating motion of the rod unit 110, 120, pumping the TPS material T from the communication hole 212 of the pressure plate 200 into the heating pipe 170 within the pumping housing 102.

Here, it is desirable for the piston 130 to be formed in a roughly concave shape with a convex underside, so that when pumping the TPS material T within the drum 20 with its reciprocating motion, the pressure on the TPS material T inside the drum 20 is increased.

The piston 130 may be constructed with a central bore 132 to accommodate the end of the second rod 120 of the rod unit, and around this central bore 132, multiple inlet ports 134 may be formed at regular intervals.

Referring to FIGS. 4 and 6, at the end of the second rod 120, a first check valve 190 may be installed to control the opening and closing of the inlet ports 134 of the piston 130 during its reciprocating motion, e.g., during ascent and descent.

Here, the first check valve 190 operates to open or close based on the pressure generated during the reciprocating motion of the piston 130 during its ascent and descent. This opening and closing action is made possible by the displacement of the first check valve 190 on the second rod 120 at the end, allowing for a certain amount of movement clearance.

The operational relationship of the first check valve 190 will be described in more detail later.

The pressure plate 200 may be provided as a disc-shaped component of a certain thickness, as mentioned earlier, with a central through-hole 212 formed for the passage of the piston 130. Additionally, sealing grooves 202 may be formed on the outer peripheral surface to accommodate sealing materials such as O-rings.

On the underside of the pressure plate 200, multiple suction holes 210 may be formed to allow the passage of the TPS material T from the drum 20, and these suction holes 210 can all be configured to communicate with the through-hole 212.

Therefore, the suction holes 210 located relatively close to the through-hole 212 on the pressure plate 200 may communicate with the lower part of the through-hole 212, while the suction holes 210 located relatively farther away from the through-hole 212 may communicate diagonally in the upward direction with the upper part of the through-hole 212.

The pumping housing 102 is provided to supply in a sealed manner the TPS material T pumped within the drum 20 to the heating pipe 170 installed on one side, in accordance with the reciprocating motion of the rod unit 110, 120 and piston 130. The pumping housing 102 may be generally cylindrical in shape with a hollow center.

Referring to FIGS. 4, 6, and 8, the second rod 120 of the rod unit 110, 120 includes: a first coupling portion 121 where the piston 130 is axially coupled; a second coupling portion 122 extending from the first coupling portion 121 for a certain length and formed with a certain vertical displacement for the first check valve 190; a small diameter portion 123 formed by extending from the second coupling portion 122 for a certain length, with a cross-sectional diameter smaller than the inner diameter of the pumping housing 102; a large diameter portion 124 formed by extending from the small diameter 123 for a certain length, with a cross-sectional diameter larger than the small diameter 123 and smaller than or similar to the inner diameter of the pumping housing 102, and multiple guide holes 126 formed along the circumference and penetrating through the front and rear of the large diameter portion 124; and a flange portion 125 formed around the circumference of the large diameter portion 124 having a certain thickness, with a cross-sectional diameter larger than the large diameter portion 124 and similar or identical to the inner diameter of the pumping housing 102.

At the central portion of the front end of the large diameter portion 124, a coupling groove 127 may be formed to a certain depth for coupling with the end portion of the first rod 110.

Here, the cross-sectional diameter of the first coupling portion 121 of the second rod 120 is the smallest, and the cross-sectional diameter of the second coupling portion 122 is larger than that of the first coupling portion 121 but smaller than that of the small diameter portion 123, forming a stepwise difference.

Therefore, when the first check valve 190 is inserted into and coupled with the second coupling portion 122, the second coupling portion 122 allows the first check valve 190 to have a certain amount of vertical movement equal to the length of the second coupling portion 122 between the piston 130 coupled with the first coupling portion 121 and the small diameter portion 123.

On the other hand, a ring-shaped packing material 150 is inserted around the perimeter of the large diameter portion 124, and the packing material 150 is tightly sealed against the inner surface of the pumping housing 102. As a result, when vertical movement occurs, reciprocating motion is facilitated, and the pumped TPS material T only moves through the guide holes 126 of the large diameter portion 124.

The internal structure of the pumping housing 102 formed by the second rod 120 as described above can be divided into three pumping chambers: the first pumping chamber S1, where communication with the interior of the drum 20 is established, the second pumping chamber S2, where opening and closing occur due to the reciprocating motion of the rod unit 110, 120 and piston 130 affecting the first pumping chamber S1, and the third pumping chamber S3, where opening and closing occur due to the reciprocating motion of the rod unit 110, 120 and piston 130 affecting the second pumping chamber S2.

Between the first pumping chamber S1 and the second pumping chamber S2, a second check valve 180 is installed to allow for a certain amount of vertical movement, and similarly, between the second pumping chamber S2 and the third pumping chamber S3, a third check valve 160 can be installed to allow for a certain amount of vertical movement.

The second check valve 180 is installed to surround the circumference of the small diameter portion 123 of the second rod 120, thereby separating the first pumping chamber S1 and the second pumping chamber S2. As it moves in the direction of pressure, it either opens or closes the passage between the first pumping chamber S1 and the second pumping chamber S2.

At the top of the second pumping chamber S2, there may be a stopper (not labeled) and a baffle 140 formed to limit the vertical movement of the second check valve 180. The baffle 140 may have multiple passage holes 142 formed in it.

Therefore, the first pumping chamber S1 within the pumping housing 102 can be the space between the piston 130 and the first check valve 190 up to the second check valve 180.

Furthermore, the second pumping chamber S2 within the pumping housing 102 can be the space between the second check valve 180 and the rear end of the large diameter portion 124 of the second rod 120.

The third pumping chamber S3 within the pumping housing 102 can be the space between the third check valve 160 and the heating pipe 170 communicating with the pumping housing 102.

In embodiments, the third check valve 160 can be installed with a certain vertical clearance at the end of the first rod 110 of the rod unit 110, 120, and depending on the direction of pressure, it can open or close the end of the guide holes 126 of the second rod 120.

Explaining the operation of the pumping device 1 for the multi-layer glass spacer material, which can be constructed as described above, the following is observed:

When the pumping device 1 for the multi-layer glass is activated to supply the TPS material T to the nozzle device for coating TPS spacers on one surface of any one of the glass panes sequentially, the lifting mechanism 30 operates to lower the pumping unit 10. Consequently, the pressure plate 200 of the pumping unit 10 is introduced into the drum 20, pressurizing the high-viscosity TPS material T filled inside the drum 20.

In this state, when the pumping unit 10 of the TPS material pumping device 1 is activated, the cylinder 100 operates to lift and reciprocate the rod unit 110, 120 and piston 130.

When the rod unit 110, 120 and piston 130 descend as shown in FIGS. 3 and 4, the TPS material T filled in the drum 20 is pressurized and flows into the communication hole 212 of the pressure plate 200 through the multiple suction holes 210 formed radially.

At the same time, the TPS material T inside the drum 20 also flows into the communication hole 212 through the multiple inlet ports 134 formed in the piston 130.

At this point, due to the pressure of the TPS material T flowing through the inlet ports 134 of the piston 130, the first check valve 190 moves a certain distance on the second coupling part 122 of the second rod 120, thereby opening the inlet ports 134 of the piston 130 into the first pumping chamber S1.

Thus, due to the pressure exerted by the TPS material inside the drum 20 as a result of the descent of the rod unit 110, 120 and piston 130, the first pumping chamber S1 is filled with TPS material T through the multiple inlet ports 134 formed in the piston 130 and the multiple through holes 212 formed in the pressure plate 200.

In this state, when the rod unit 110, 120 and piston 130 ascend as shown in FIGS. 5 and 6, the TPS material T filled in the first pumping chamber S1 moves to the second pumping chamber S2 due to the pressure caused by the ascent of the piston 130.

As the piston 130 ascends, the volume of the first pumping chamber S1 decreases. Due to the pressure of the TPS material T inside the first pumping chamber S1, the first check valve 190 closes by adhering to the piston 130, thereby blocking the inlet ports 134 of the piston 130. Consequently, the TPS material T inside the first pumping chamber S1 is prevented from flowing back into the drum 20 through the inlet ports 134 of the piston 130.

Furthermore, as the piston 130 descends, the amount of TPS material T filling the first pumping chamber S1 decreases the amount of TPS material T within the drum 20. As the filling height decreases, the pumping unit 10 descends to continue pressurizing the TPS material T inside the drum 20. Consequently, even as the TPS material T is drawn into the first pumping chamber S1 through the suction holes 210 of the pressure plate 200, the pumping unit 10 pressurizing the TPS material T prevents the TPS material from flowing from the first pumping chamber S1 back into the drum 20.

Meanwhile, the second check valve 180, which separates the first pumping chamber S1 from the second pumping chamber S2, rises along the guide of the small diameter portion 123 of the second rod 120 as the pressure of the TPS material T within in the first pumping chamber S1 due to the ascent of the piston 130 causes it to move away from the ledge and adhere to the baffle 140.

Therefore, as the first pumping chamber S1 and the second pumping chamber S2 are open to each other, the volume of the first pumping chamber S1 decreases, causing the TPS material T inside the first pumping chamber S1 to be filled into the second pumping chamber S2.

In this case, if the volume of the second pumping chamber S2 is smaller than that of the first pumping chamber S1, some of the TPS material T may, under pressure, pass through the multiple guide holes 126 formed in the large diameter portion 124 of the second rod 120. Then, the third check valve 160 is opened, allowing the TPS material to be filled into the third pumping chamber S3.

In this situation, as the rod unit 110, 120 and piston 130 descend again as shown in FIGS. 3 and 4, the large diameter portion 124 of the second rod 120 and the packing material 150 surrounding the large diameter portion 124 descend as well. Consequently, the volume of the second pumping chamber S2 decreases. As a result, the TPS material T filled in the second pumping chamber S2 is pressured to pass through the multiple guide holes 126 formed in the large diameter portion 124 and is thus filled into the third pumping chamber S3.

Further, the third check valve 160 rises in response to the pressure of the TPS material T passing through the guide holes 126 in the large diameter portion 124. This action opens up the second pumping chamber S2 to the third pumping chamber S3. As a result, the TPS material T filled in the second pumping chamber S2 is moved into the third pumping chamber S3.

In this case, the volume of the third pumping chamber S3 is formed to be smaller than that of the second pumping chamber S2. Consequently, the TPS material T filled into the third pumping chamber S3 is supplied to the nozzle device through the heating pipe 170 which is connected to the third pumping chamber S3.

As the volume of the second pumping chamber S2 decreases, the pressure of the TPS material T causes the second check valve 180 to descend again and be sealed against the step portion. Consequently, the TPS material T filled in the second pumping chamber S2 prevents the outflow back into the first pumping chamber S1.

As the rod unit 110, 120 and piston 130 descend, causing the TPS material T in the second pumping chamber S2 to fill the third pumping chamber S3 and be supplied through the heating pipe 170, the first pumping chamber S1 is refilled with TPS material T from the drum 20. Since the operation of this process has been previously explained, it will not be repeated.

As the rod unit 110, 120 and piston 130 rise again, the TPS material T filled in the first pumping chamber S1 is transferred to the second pumping chamber S2, as explained earlier. At this point, any remaining TPS material T in the third pumping chamber S3 also decreases in volume, allowing it to be supplied through the heating pipe 170 to the nozzle device.

Of course, in this case, as the volume of the second pumping chamber S2 increases and the volume of the third pumping chamber S3 decreases, the third check valve 160 is acted upon by the TPS material T filled in the third pumping chamber S3, causing pressure to act on it. Consequently, the guide holes 126 formed in the flange 124 of the second rod 120 are closed off, preventing the TPS material T in the third pumping chamber S3 from flowing out into the second pumping chamber S2.

Meanwhile, as the volume of the third pumping chamber S3 connected to the heating pipe 170 is formed to be smaller than that of the second pumping chamber S2, during the reciprocating motion of the lifting and lowering of the rod unit 110, 120 and piston 130, an appropriate amount of TPS material T can be supplied to the nozzle device through the heating pipe 170.

As described above, according to the embodiments of the pumping device 1 for TPS material used for sealing double-glazed panes, the pumping performance for high-viscosity TPS material T is significantly improved, thereby providing the effect of smoothly supplying the desired amount of TPS material T to the nozzle device.

In other words, during the reciprocating motion of the piston 130 causing the rise and fall, the high-viscosity TPS material T filled in the drum 20 is pumped. During the pumping process, minimal loss of TPS material T occurs, ensuring an adequate amount of TPS material T is supplied to the nozzle device. This prevents defective TPS material T application, ultimately leading to the production of high-quality IGUs. The TPS material T is then applied from the nozzle device onto a primary surface of a glass pane. The TPS material T so applied on the glass pane then acts as a spacer as the glass pane with the TPS material T is bonded to another glass pane to form an IGU. The spacer maintains a space between the glass panes bonded together. The space is filled with gas, such as argon.

Those skilled in the art to which the present disclosure pertains will understand that the disclosure can be implemented in other specific forms without altering its technical essence or essential features. Therefore, the embodiments described above should be understood as illustrative in all aspects and not limiting. The scope of the invention is defined by the claims set forth below rather than the detailed description provided above, and any modifications or variations derived from the meaning and scope of the claims and the concept of equivalents are to be interpreted as included within the scope of the disclosure.

According to a first aspect of the present disclosure, a pumping device to pump spacer material to a nozzle comprises: (1) a pumping unit comprising: (a) a cylinder configured to be driven in a reciprocating manner by a control signal; (b) a rod unit connected to the cylinder, the rod unit movable in a reciprocating manner as the cylinder is driven in the reciprocating manner; (c) a piston installed at the end of the rod unit, the piston movable in a reciprocating manner, as the cylinder is driven in the reciprocating manner, to, from, and between a lowered state and a raised state; (d) a pressure plate comprising (i) a through-hole through which the piston can pass as the cylinder is driven in a reciprocating manner and (ii) an outer peripheral surface configured to cooperate with a drum containing spacer material; and (e) a pumping housing enveloping the rod unit to maintain a sealed environment and comprising a hollow center; (2) a support unit supporting the pumping unit; and (3) a lifting unit configured to raise and to lower the support unit so that the pressure plate pressurizes the spacer material within the drum as the spacer material is withdrawn from the drum by the reciprocating movement of the cylinder.

According to a second aspect of the present disclosure, the pumping device of the first aspect is presented, wherein the rod unit comprises a first rod with a diameter that is smaller than an inner diameter of the pumping housing thus forming a clearance between the pumping housing and the first rod configured for movement of the spacer material therethrough.

According to a third aspect of the present disclosure, the pumping device of any one of the first through second aspects is presented, wherein (a) the rod unit further comprises a second rod, and (b) the second rod comprises (i) a first coupling portion to which the piston is coupled and (ii) a coupling groove that is coupled to the first rod.

According to a fourth aspect of the present disclosure, the pumping device of the third aspect is presented, wherein the piston comprises a central bore to accommodate the first coupling portion of the second rod.

According to a fifth aspect of the present disclosure, the pumping device of any one of the first through fourth aspects is presented, wherein the pumping housing comprises a heating pipe.

According to a sixth aspect of the present disclosure, the pumping device of any one of the first through fifth aspects is presented, wherein the piston comprises inlet ports configured to direct flow of the spacer material as the piston moves to, from, and between the lowered state and the raised state.

According to a seventh aspect of the present disclosure, the pumping device of the sixth aspect is presented, wherein (i) the pumping unit further comprises a first check valve installed on the rod unit and positioned to control opening and closing of the inlet ports as the piston moves in its reciprocating manner, and (ii) the first check valve has movement clearance upon the rod unit so that the first check valve can be displaced and thereby open and close the inlet ports during the reciprocating movement of the piston.

According to an eighth aspect of the present disclosure, the pumping device of any one of the first through seventh aspects is presented, wherein the pressure plate further comprises sealing grooves formed on the outer peripheral surface configured to accommodate sealing materials to seal against the drum containing the spacer material.

According to a ninth aspect of the present disclosure, the pumping device of any one of the first through eighth aspects is presented, wherein (i) the pressure plate further comprises suction holes open at an underside of the pressure plate, (ii) the underside is positioned to face the spacer material within the drum, and (iii) the suction holes are in communication with the through-hole of the pressure plate.

According to a tenth aspect of the present disclosure, the pumping device of the ninth aspect is presented, wherein (i) the suction holes include a first series and a second series, (ii) the first series are open at the underside of the pressure plate closer to the through-hole than the second series, (iii) the first series are open to a lower part of the through-hole, and (iv) the second series are open to an upper part of the through-hole and extend diagonally in an upward direction from the underside to the through-hole of the pressure plate.

According to an eleventh aspect of the present disclosure, the pumping device of the first through tenth aspects is presented, wherein the rod unit comprises: (i) a first coupling portion to which the piston is axially coupled; (ii) a second coupling portion to which a first check valve is coupled, the second coupling portion extending from the first coupling portion for a length sufficient to allow vertical displacement of the first check valve on the second coupling portion; (iii) a small diameter portion extending from the second coupling portion; (iv) a large diameter portion extending from the small diameter portion, the large diameter portion having a diameter that is larger than a diameter of the small diameter portion; and (v) guide holes extending axially through the large diameter portion and open at a front and a rear of the larger diameter portion, the guide holes positioned to guide the spacer material during the reciprocating motion of the rod unit.

According to a twelfth aspect of the present disclosure, the pumping device of the eleventh aspect is presented, wherein the rod unit further comprising a flange portion extending radially outward from the large diameter portion and comprising a diameter approximately the same as an inner diameter of the pumping housing.

According to a thirteenth aspect of the present disclosure, the pumping device of any one of the eleventh through twelfth aspects is presented, wherein (i) the first coupling portion of the rod unit has a diameter that is smaller than a diameter of the second coupling portion and the diameter of the smaller diameter portion, (ii) the diameter of the second coupling portion is smaller than the diameter of the smaller diameter portion, and (iii) the diameters of the first coupling portion, the second coupling portion, and the smaller diameter portion transition in a stepwise manner.

According to a fourteenth aspect of the present disclosure, the pumping device of the thirteenth aspect is presented, wherein the second coupling portion allows the first check valve to have a fixed amount of axial movement along the second coupling portion between the piston coupled to the first coupling portion and the small diameter portion.

According to a fifteenth aspect of the present disclosure, the pumping device of any one of the eleventh through fourteenth aspects is presented, wherein the rod unit further comprises a ring-shaped packing material inserted around the perimeter of the large diameter portion, the ring-shaped packing material being tightly sealed against an inner surface of the pumping housing.

According to a sixteenth aspect of the present disclosure, the pumping device of any one of the eleventh through fifteenth aspects is presented, wherein (a) in addition to the first check valve, the pumping unit further comprises (i) a second check valve installed to surround a circumference of the small diameter portion of the rod unit and (ii) a third check valve coupled to the rod unit within the pumping housing, and (b) the first check valve, the second check valve, and the third check valve divide the pumping housing into (i) a first pumping chamber between the first check valve and the second check valve, (ii) a second pumping chamber between the second check valve and the rear of the large diameter portion of the rod unit, and (iii) a third pumping chamber between the third check valve and a heating pipe of the pumping housing.

According to a seventeenth aspect of the present disclosure, the pumping device of the sixteenth aspects is presented, wherein (i) the second check valve and the third check valve are coupled to the rod unit in a manner that allows for axial movement thereupon, (ii) opening and closing of the second pumping chamber occur due to movement of the second check valve during the reciprocating motion of the rod unit and the piston, and (iii) opening and closing occur of the third pumping chamber occur due to movement of the third check valve during the reciprocating motion of the rod unit and the piston affecting the second pumping chamber.

According to an eighteenth aspect of the present disclosure, a method of pumping spacer material comprises: pumping spacer material from a drum containing the spacer material with the pumping device of any one of the first through seventeenth aspects to a nozzle device configured to apply the spacer material onto a glass pane.

According to a nineteenth aspect of the present disclosure, the method of the eighteenth aspect is presented, wherein the spacer material is TPS material.

According to a twentieth aspect of the present disclosure, a method of pumping spacer material comprises: (a) lowering a pressure plate of a pumping unit into a drum containing spacer material so that the pressure plate pressurizes the spacer material, the pressure plate comprising a communication hole and suction holes formed radially around the communication hole; and (b) moving a cylinder of the pumping unit in a reciprocating manner, the movement of the cylinder causing reciprocating movement of a rod unit coupled to the cylinder and a piston coupled to the rod unit, wherein during the reciprocating movement of the piston, (i) the piston extends through the communication hole of the pressure plate, (ii) the spacer material flows into the communication hole of the pressure plate through the suction holes of the pressure plate, and (iii) the spacer material additionally flows into the communication hole through inlet ports formed in the piston.

According to a twenty-first aspect of the present disclosure, the method of the twentieth aspect is presented, wherein due to pressure of the spacer material flowing through the inlet ports of the piston, a first check valve coupled to the rod unit of the pumping unit moves axially along the rod unit and thereby opens the inlet ports of the piston into a first pumping chamber of the pumping unit, thus allowing the spacer material to flow into and fill the first pumping chamber.

According to a twenty-second aspect of the present disclosure, the method of the twenty-first aspect is presented, wherein during the reciprocating movement of the piston and the rod unit, the piston moves away from the pressure plate, thereby causing (i) the first pumping chamber to reduce in volume, (ii) a second check valve of the pumping unit separating the first pumping chamber from a second pumping chamber to move axially along the rod unit away from the pressure plate to open the second pumping chamber, (iii) the spacer material within the first pumping chamber to move to the second pumping chamber, (iv) and the first check valve to close the inlet ports of the piston, preventing backflow of the spacer material through the inlet ports.

According to a twenty-third aspect of the present disclosure, the method of the twenty-second aspect is presented, wherein as the piston moves away from the pressure plate, the spacer material within the second pumping chamber passes through guide holes formed in a large diameter portion of the rod unit, force open a third check valve, and pass into a third pumping chamber formed by the third check valve and a heating pipe.

According to a twenty-fourth aspect of the present disclosure, the method of the twenty-third aspect is presented, wherein during the reciprocating movement of the piston and the rod unit, as the piston moves back toward the pressure plate, the large diameter portion of the rod unit moves toward the pressure plate as well, thereby (i) decreasing a volume of the second pumping chamber, (ii) pressuring the spacer material within the second pumping chamber to pass through the guide holes of the large diameter portion and enter the third pumping chamber, and (iii) pressuring the spacer material within the second pumping chamber to push the second check valve axially along the rod unit and close to prevent outflow back into the first pumping chamber.

According to a twenty-fifth aspect of the present disclosure, the method of the twenty-fourth aspect is presented, wherein during the reciprocating movement of the piston and the rod unit, as the piston moves away from the pressure plate, (i) volume of the third pumping chamber decreases, (ii) the spacer material within the third pumping chamber pressures the third check valve to close the guide holes of the large diameter portion, thereby preventing backflow of the spacer material in the third pumping chamber to the second pumping chamber, and (iii) the spacer material within the heating pipe of third pumping chamber is directed to a nozzle device.

According to a twenty-sixth aspect of the present disclosure, the method of any one of the twentieth through the twenty-fifth aspect is presented, wherein during the reciprocating movement of the piston where the piston extends through the communication hole of the pressure plate, (i) the spacer material entering the communication hole of the pressure plate thereby decreasing an amount of spacer material within the drum and (ii) the lowering of the pressure plate continues to maintain pressurizing of the spacer material inside the drum.

According to a twenty-seventh aspect of the present disclosure, the method of any one of the twentieth through the twenty-sixth aspects further comprises: applying the spacer material from a nozzle in fluid communication with the pumping unit onto a glass pane.

According to a twenty-eighth aspect of the present disclosure, the method of any one of the twentieth through the twenty-seventh aspects is presented, wherein the spacer material is TPS material.

### EXPLANATION OF SYMBOLS

1: Pumping device
10: Pumping unit
20: Drum
30: Lifting Unit
40: Support Unit
100: Cylinder (drive unit)
102: Pumping housing
110: First rod
120: Second rod
121: First coupling portion
122: Second coupling portion
123: Small diameter portion
124: Large diameter portion
125: Flange portion
126: Guide holes
127: Coupling groove
130: Piston
132: Central bore
134: Inlet port
140: Baffle
142: Passage hole
150: Packing material
160: Third check valve
170: Heating pipe
180: Second check valve
190: First check valve
200: Pressure plate
202: Sealing groove
210: Suction hole
212: central through-hole
S1: First pumping chamber
S2: Second pumping chamber
S3: Third pumping chamber
T: Spacer material

What is claimed is:

1. A pumping device to pump spacer material to a nozzle comprising:
a pumping unit comprising:
a cylinder configured to be driven in a reciprocating manner by a control signal;
a rod unit connected to the cylinder, the rod unit movable in a reciprocating manner as the cylinder is driven in the reciprocating manner;
a piston installed at the end of the rod unit, the piston movable in a reciprocating manner, as the cylinder is driven in the reciprocating manner, to, from, and between a lowered state and a raised state;
a pressure plate comprising (i) a through-hole through which the piston can pass as the cylinder is driven in a reciprocating manner and (ii) an outer peripheral surface configured to cooperate with a drum containing spacer material; and
a pumping housing enveloping the rod unit to maintain a sealed environment and comprising a hollow center;
a support unit supporting the pumping unit; and
a lifting unit configured to raise and to lower the support unit so that the pressure plate pressurizes the spacer material within the drum as the spacer material is withdrawn from the drum by the reciprocating movement of the cylinder.

2. The pumping device of claim 1, wherein
the rod unit comprises a first rod with a diameter that is smaller than an inner diameter of the pumping housing thus forming a clearance between the pumping housing and the first rod configured for movement of the spacer material therethrough.

3. The pumping device of claim 1, wherein
the rod unit further comprises a second rod, and
the second rod comprises (i) a first coupling portion to which the piston is coupled and (ii) a coupling groove that is coupled to the first rod.

4. The pumping device of claim 3, wherein
the piston comprises a central bore to accommodate the first coupling portion of the second rod.

5. The pumping device of claim 1, wherein
the pumping housing comprises a heating pipe.

6. The pumping device of claim 1, wherein
the piston comprises inlet ports configured to direct flow of the spacer material as the piston moves to, from, and between the lowered state and the raised state.

7. The pumping device of claim 6, wherein
the pumping unit further comprises a first check valve installed on the rod unit and positioned to control opening and closing of the inlet ports as the piston moves in its reciprocating manner, and
the first check valve has movement clearance upon the rod unit so that the first check valve can be displaced and thereby open and close the inlet ports during the reciprocating movement of the piston.

8. The pumping device of claim 1, wherein
the pressure plate further comprises sealing grooves formed on the outer peripheral surface configured to accommodate sealing materials to seal against the drum containing the spacer material.

9. The pumping device of claim 1, wherein
the pressure plate further comprises suction holes open at an underside of the pressure plate,
the underside is positioned to face the spacer material within the drum, and
the suction holes are in communication with the through-hole of the pressure plate.

10. The pumping device of claim 9, wherein
the suction holes include a first series and a second series,
the first series are open at the underside of the pressure plate closer to the through-hole than the second series,
the first series are open to a lower part of the through-hole, and
the second series are open to an upper part of the through-hole and extend diagonally in an upward direction from the underside to the through-hole of the pressure plate.

11. The pumping device of claim 1, wherein
the rod unit comprises:
a first coupling portion to which the piston is axially coupled;
a second coupling portion to which a first check valve is coupled, the second coupling portion extending from the first coupling portion for a length sufficient to allow vertical displacement of the first check valve on the second coupling portion;
a small diameter portion extending from the second coupling portion;
a large diameter portion extending from the small diameter portion, the large diameter portion having a diameter that is larger than a diameter of the small diameter portion; and
guide holes extending axially through the large diameter portion and open at a front and a rear of the larger diameter portion, the guide holes positioned to guide the spacer material during the reciprocating motion of the rod unit.

12. The pumping device of claim 11, wherein
the rod unit further comprising a flange portion extending radially outward from the large diameter portion and comprising a diameter approximately the same as an inner diameter of the pumping housing.

13. The pumping device of claim 11, wherein
the first coupling portion of the rod unit has a diameter that is smaller than a diameter of the second coupling portion and the diameter of the smaller diameter portion,
the diameter of the second coupling portion is smaller than the diameter of the smaller diameter portion, and
the diameters of the first coupling portion, the second coupling portion, and the smaller diameter portion transition in a stepwise manner.

14. The pumping device of claim 13, wherein
the second coupling portion allows the first check valve to have a fixed amount of axial movement along the second coupling portion between the piston coupled to the first coupling portion and the small diameter portion.

15. The pumping device of claim 11, wherein
the rod unit further comprises a ring-shaped packing material inserted around the perimeter of the large diameter portion, the ring-shaped packing material being tightly sealed against an inner surface of the pumping housing.

16. The pumping device of claim 11, wherein
in addition to the first check valve, the pumping unit further comprises (i) a second check valve installed to surround a circumference of the small diameter portion of the rod unit and (ii) a third check valve coupled to the rod unit within the pumping housing, and
the first check valve, the second check valve, and the third check valve divide the pumping housing into (i) a first pumping chamber between the first check valve and the second check valve, (ii) a second pumping chamber between the second check valve and the rear of the large diameter portion of the rod unit, and (iii) a third pumping chamber between the third check valve and a heating pipe of the pumping housing.

17. The pumping device of claim 16, wherein
the second check valve and the third check valve are coupled to the rod unit in a manner that allows for axial movement thereupon,
opening and closing of the second pumping chamber occur due to movement of the second check valve during the reciprocating motion of the rod unit and the piston, and
opening and closing occur of the third pumping chamber occur due to movement of the third check valve during the reciprocating motion of the rod unit and the piston affecting the second pumping chamber.

18. A method of pumping spacer material comprising:
pumping spacer material from a drum containing the spacer material with the pumping device of claim 1 to a nozzle device configured to apply the spacer material onto a glass pane.

19. The method of claim 18, wherein
the spacer material is TPS material.

20. A method of pumping spacer material comprising:
lowering a pressure plate of a pumping unit into a drum containing spacer material so that the pressure plate pressurizes the spacer material, the pressure plate comprising a communication hole and suction holes formed radially around the communication hole; and
moving a cylinder of the pumping unit in a reciprocating manner, the movement of the cylinder causing reciprocating movement of a rod unit coupled to the cylinder and a piston coupled to the rod unit, wherein during the reciprocating movement of the piston, (i) the piston extends through the communication hole of the pressure plate, (ii) the spacer material flows into the communication hole of the pressure plate through the suction holes of the pressure plate, and (iii) the spacer material additionally flows into the communication hole through inlet ports formed in the piston.

21. The method of claim 20, wherein
due to pressure of the spacer material flowing through the inlet ports of the piston, a first check valve coupled to the rod unit of the pumping unit moves axially along the rod unit and thereby opens the inlet ports of the piston into a first pumping chamber of the pumping unit, thus allowing the spacer material to flow into and fill the first pumping chamber.

22. The method of claim 21, wherein
during the reciprocating movement of the piston and the rod unit, the piston moves away from the pressure plate, thereby causing (i) the first pumping chamber to reduce in volume, (ii) a second check valve of the pumping unit separating the first pumping chamber from a second pumping chamber to move axially along the rod unit away from the pressure plate to open the second pumping chamber, (iii) the spacer material within the first pumping chamber to move to the second pumping chamber, (iv) and the first check valve to close the inlet ports of the piston, preventing backflow of the spacer material through the inlet ports.

23. The method of claim 22, wherein
as the piston moves away from the pressure plate, the spacer material within the second pumping chamber passes through guide holes formed in a large diameter portion of the rod unit, force open a third check valve, and pass into a third pumping chamber formed by the third check valve and a heating pipe.

24. The method of claim 23, wherein
during the reciprocating movement of the piston and the rod unit, as the piston moves back toward the pressure plate, the large diameter portion of the rod unit moves toward the pressure plate as well, thereby (i) decreasing a volume of the second pumping chamber, (ii) pressuring the spacer material within the second pumping chamber to pass through the guide holes of the large diameter portion and enter the third pumping chamber, and (iii) pressuring the spacer material within the second pumping chamber to push the second check valve axially along the rod unit and close to prevent outflow back into the first pumping chamber.

25. The method of claim 24, wherein
during the reciprocating movement of the piston and the rod unit, as the piston moves away from the pressure plate, (i) volume of the third pumping chamber decreases, (ii) the spacer material within the third pumping chamber pressures the third check valve to close the guide holes of the large diameter portion, thereby preventing backflow of the spacer material in the third pumping chamber to the second pumping chamber, and (iii) the spacer material within the heating pipe of third pumping chamber is directed to a nozzle device.

26. The method of claim 20, wherein
during the reciprocating movement of the piston where the piston extends through the communication hole of the pressure plate, (i) the spacer material entering the communication hole of the pressure plate thereby decreasing an amount of spacer material within the drum and (ii) the lowering of the pressure plate continues to maintain pressurizing of the spacer material inside the drum.

27. The method of claim 20 further comprising:
applying the spacer material from a nozzle in fluid communication with the pumping unit onto a glass pane.

28. The method of claim 20, wherein
the spacer material is TPS material.
